(19) United States
(12) Patent Application Publication
(10) Pub. No.: US 2016/0267075 A1
(43) Pub. Date: Sep. 15, 2016

(54) WEARABLE DEVICE AND TRANSLATION SYSTEM

(71) Applicant: Panasonic Intellectual Property Management Co., Ltd., Osaka (JP)

(72) Inventor: Tomokazu ISHIKAWA, Osaka (JP)

(21) Appl. No.: 15/067,036

(22) Filed: Mar. 10, 2016

(30) Foreign Application Priority Data
Mar. 13, 2015 (JP) 2015-050942
Feb. 3, 2016 (JP) 2016-018575

(51) Int. Cl. G06F 17/28; H04R 29/00; G10L 13/04

(52) U.S. Cl. CPC G06F 17/289; G10L 13/043; H04R 29/004; H04R 2203/12

(57) ABSTRACT

A wearable translation device attachable to a body of a user includes a microphone device that obtains a voice of a first language from the user and generates an audio signal of the first language, and a control circuit that obtains an audio signal of a second language converted from the audio signal of the first language. The wearable translation device further includes an audio processing circuit that executes a predetermined process on the audio signal of the second language, and a speaker device that outputs the processed audio signal of the second language as a voice. Further, when detection is made that a vocal part of the user is located above the speaker device, the audio processing circuit moves a sound image of the speaker device from a position of the speaker device toward a position of the vocal part of the user according to the detection.

### BACKGROUND

1. Technical Field

The present disclosure relates to a wearable device that is attached to a user's body to be used for automatically translating conversations between speakers of different languages in real time, and it also relates to a translation system including a wearable device of this type.

2. Description of the Related Art

According to development of techniques of speech recognition, machine translation, and voice synthesis, translation devices that automatically translate conversations between speakers of different languages in real time have been known. Such translation devices include portable or wearable devices.

For example, PTL 1 discloses an automatic translation device that performs automatic translation communication even outdoors in noisy conditions noises in a more natural form.

### CITATION LIST

### Patent Literatures

PTL 1: Unexamined Japanese Patent Publication No. 2007-272260

PTL 2: Unexamined Japanese Patent Publication No. 2012-093705

PTL 3: International Publication No. 2009/101778

PTL 4: Unexamined Japanese Patent Publication No. 2009-296110

The entire disclosures of these Patent Literatures are incorporated herein by reference.

In order to improve convenience of a translation device, for example, it is necessary to make speakers and listeners unaware of presence of the translation device as much as possible during use of the translation device so that the speakers and the listeners would feel they are making natural conversations even through the translation device.

### SUMMARY

The present disclosure provides a wearable device and a translation system that keep natural conversations between speakers of different languages.

A wearable device of the present disclosure includes a microphone device that obtains a voice of a first language from a user and generates an audio signal of the first language, and a control circuit that obtains an audio signal of a second language converted from the audio signal of the first language. Further, the wearable device includes an audio processing circuit that executes a predetermined process on the audio signal of the second language, and a speaker device that outputs the processed audio signal of the second language as a voice. Further, when detection is made that a vocal part of the user is located above the speaker device, the audio processing circuit moves a sound image of the speaker device from a position of the speaker device toward a position of the user's vocal part according to the detection.

The wearable device and the translation system of the present disclosure are effective for keeping natural conversations when conversations between speakers of different languages are translated.

### BRIEF DESCRIPTION OF DRAWINGS

FIG. 1 is a block diagram illustrating a configuration of a translation system according to a first exemplary embodiment;

FIG. 2 is a diagram illustrating a first example of a state in which a user wears a wearable translation device of the translation system according to the first exemplary embodiment;

FIG. 3 is a diagram illustrating a second example of a state in which the user wears the wearable translation device of the translation system according to the first exemplary embodiment;

FIG. 4 is a diagram illustrating a third example of a state in which the user wears the wearable translation device of the translation system according to the first exemplary embodiment;

FIG. 5 is a sequence diagram illustrating an operation of the translation system according to the first exemplary embodiment;

FIG. 6 is a diagram illustrating measurement of a distance from a speaker device of the wearable translation device of the translation system to a user's vocal part according to the first exemplary embodiment;

FIG. 7 is a diagram illustrating a rise of a sound image when the wearable translation device of the translation system according to the first exemplary embodiment is used;

FIG. 8 is a diagram illustrating an example of a state in which the user wears the wearable translation device of the translation system according to a second exemplary embodiment;

FIG. 9 is a block diagram illustrating a configuration of the translation system according to a third exemplary embodiment;

FIG. 10 is a block diagram illustrating a configuration of the translation system according to a fourth exemplary embodiment;

FIG. 11 is a sequence diagram illustrating an operation of the translation system according to the fourth exemplary embodiment; and

FIG. 12 is a block diagram illustrating a configuration of the wearable translation device of the translation system according to the fifth exemplary embodiment.

### DETAILED DESCRIPTION OF EMBODIMENTS

Exemplary embodiments are described in detail below with reference to the drawings. Description that is in more detail than necessary is occasionally omitted. For example, detailed description about already well-known matters and overlapped description about the substantially same configurations are occasionally omitted. This is because the following description is avoided from being unnecessarily redundant, and a person skilled in the art is made to easily understand the present disclosure.

The accompanying drawings and the following description are provided for a person skilled in the art to fully understand the present disclosure, and do not intend to limit the subject matter described in Claims.

### First Exemplary Embodiment

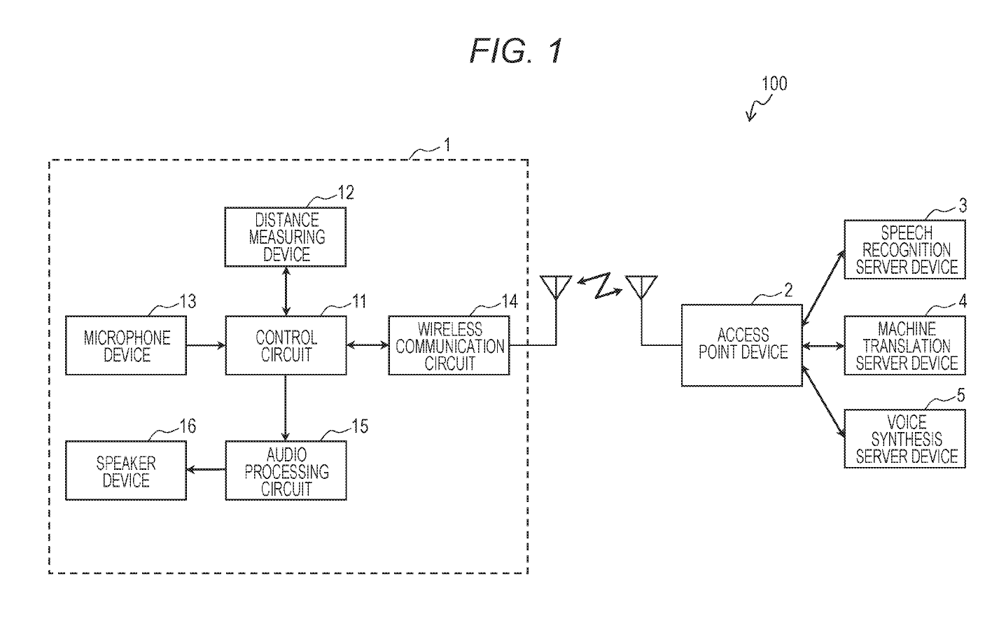

A translation system according to the first exemplary embodiment is described below with reference to FIG. 1 to FIG. 7.

### 1-1. Configuration

FIG. 1 is a block diagram illustrating a configuration of the translation system according to the first exemplary embodiment. Translation system 100 includes wearable translation device 1, access point device 2, speech recognition server device 3, machine translation server device 4, and voice synthesis server device 5.

Wearable translation device 1 can be attached to a predetermined position of a user's body. Wearable translation device 1 is attached to a thoracic region or an abdominal region of the user, for example. Wearable translation device 1 wirelessly communicates with access point device 2.

Access point device 2 communicates with speech recognition server device 3, machine translation server device 4, and voice synthesis server device 5 via the Internet, for example. Therefore, wearable translation device 1 communicates with speech recognition server device 3, machine translation server device 4, and voice synthesis server device 5 via access point device 2. Speech recognition server device 3 converts an audio signal into a text. Machine translation server device 4 converts a text of a first language into a text of a second language. Voice synthesis server device 5 converts a text into an audio signal.

Speech recognition server device 3, machine translation server device 4, and voice synthesis server device 5 are computer devices each of which has a control circuit such as a CPU and a memory. In speech recognition server device 3, the control circuit executes a process for converting an audio signal of a first language into a text of the first language according to a predetermined program. In machine translation server device 4, the control circuit executes a process for converting the text of the first language into a text of a second language according to a predetermined program. In voice synthesis server device 5, the control circuit converts the text of the second language into an audio signal of the second language according to a predetermined program. In this exemplary embodiment, speech recognition server device 3, machine translation server device 4, and voice synthesis server device 5 are formed by individual computer devices. They may be, however, formed by a single server device, or formed by a plurality of server devices so as to execute distributed functions.

In this exemplary embodiment, a case where a user of wearable translation device 1 is a speaker of a first language and the user converses with a speaker of a second language who is face-to-face with the user will be described. In the following description, the speaker of the second language does not utter a voice and participates in a conversation as a listener.

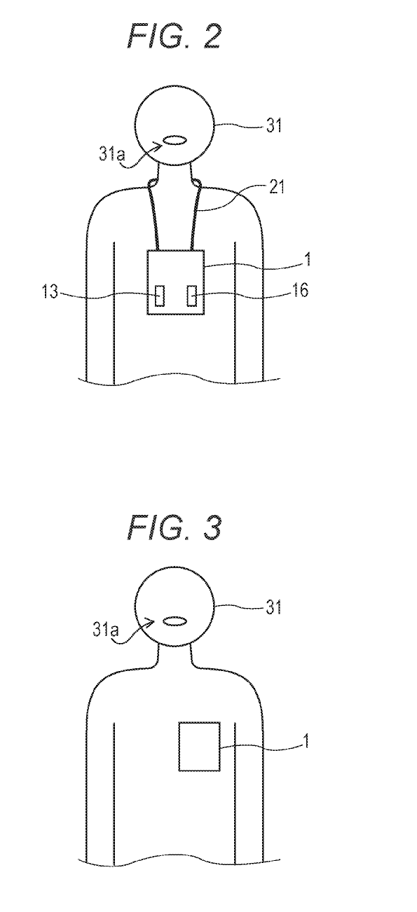

Wearable translation device 1 includes control circuit 11, distance measuring device 12, microphone device 13, wireless communication circuit 14, audio processing circuit 15, and speaker device 16. Distance measuring device 12 measures a distance between speaker device 16 and vocal part 31a (as shown in FIG. 2 to FIG. 4) of the user. The vocal part means a portion including not only a user's mouth but also a region around the user's mouth such as a jaw and an area under a nose. Namely, the vocal part is a portion where information about a distance from speaker device 16 can be obtained.

Microphone device 13 obtains a voice of the first language from the user and generates an audio signal of the first language. Wireless communication circuit 14 communicates with speech recognition server device 3, machine translation server device 4, and voice synthesis server device 5, which are outside wearable translation device 1, via access point device 2. Control circuit 11 obtains an audio signal of the second language, which has been translated from the audio signal of the first language, from speech recognition server device 3, machine translation server device 4, and voice synthesis server device 5, via wireless communication circuit 14. Audio processing circuit 15 executes a predetermined process on the obtained audio signal of the second language. Speaker device 16 outputs the processed audio signal of the second language as a voice.

FIG. 2 is a diagram illustrating a first example of a state in which user 31 wears wearable translation device 1 of translation system 100 according to the first exemplary embodiment. User 31 wears wearable translation device 1 on a neck of user 31 using strap 21, for example, such that wearable translation device 1 is located at a thoracic region or abdominal region of user 31. Microphone device 13 is a microphone array including at least two microphones arranged in a vertical direction with respect to the ground when user 31 wears wearable translation device 1 as shown in FIG. 2, for example. Microphone device 13 has a beam in a direction from microphone device 13 to vocal part 31a of the user. Speaker device 16 is provided so as to output a voice toward the listener who is face-to-face with user 31 when user 31 wears wearable translation device 1 as shown in FIG. 2.

FIG. 3 is a diagram illustrating a second example of a state in which user 31 wears wearable translation device 1 of translation system 100 according to the first exemplary embodiment. Wearable translation device 1 may be attached to a thoracic region or an abdominal region of clothes, which user 31 wears, by a pin or the like. Wearable translation device 1 may be in the form of a name plate.

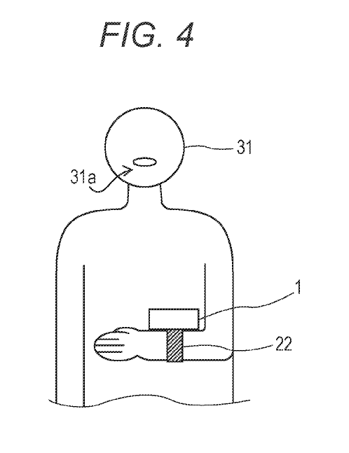

FIG. 4 is a diagram illustrating a third example of a state in which user 31 wears wearable translation device 1 of translation system 100 according to the first exemplary embodiment. Wearable translation device 1 may be attached to an arm of user 31 through belt 22, for example.

Conventionally, when a speaker of the translation device is distant from vocal part 31a (for example, the mouth) of the speaker during use of the translation device, a translated voice is heard from a place different from vocal part 31a, and thus the listener feels uncomfortable. In order to improve convenience of the translation device, even when the translation device is used, it is necessary to make the speaker and the listener unaware of presence of the translation device as much as possible so that the speaker would feel he or she is making natural conversations.

For this reason, in wearable translation device 1 of translation system 100 according to this exemplary embodiment, when detection is made that vocal part 31a of user 31 is present above speaker device 16, as described below, audio processing circuit 15 moves a sound image of speaker device 16 from a position of speaker device 16 to a position of vocal part 31a of user 31 according to the detection. When vocal part 31a of user 31 is not detected, audio processing circuit 15 does not move the sound image of speaker device 16.

### 1-2. Operation

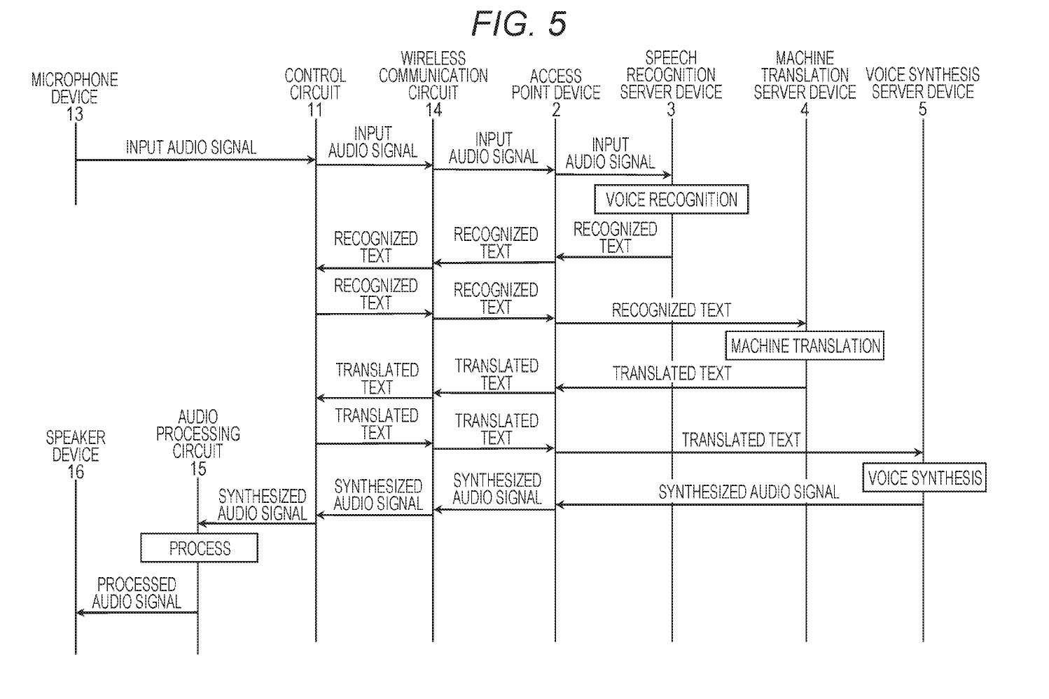

FIG. 5 is a sequence diagram illustrating an operation of translation system 100 according to the first exemplary embodiment. When an audio signal of a first language is input by user 31 using microphone device 13, control circuit 11 transmits the input audio signal to speech recognition server device 3. Speech recognition server device 3 performs speech recognition on the input audio signal, and generates a text of the recognized first language and transmits the text to control circuit 11. When control circuit 11 receives the text of the first language from speech recognition server device 3, control circuit 11 transmits the text of the first language as well as a control signal to machine translation server device 4. The control signal includes an instruction that the first language should be translated into the second language. Machine translation server device 4 performs machine translation on the text of the first language, and generates a translated text of the second language and transmits the translated text to control circuit 11. When control circuit 11 receives the text of the second language from machine translation server device 4, control circuit 11 transmits the text of the second language to voice synthesis server device 5. Voice synthesis server device 5 performs voice synthesis on the text of the second language, and generates an audio signal of the synthesized second language and transmits the audio signal to control circuit 11. When control circuit 11 receives the audio signal of the second language from voice synthesis server device 5, control circuit 11 transmits the audio signal of the second language to audio processing circuit 15. When the detection is made that vocal part 31a of user 31 is located above speaker device 16, audio processing circuit 15 processes the audio signal of the second language so that the sound image of speaker device 16 is moved from the position of speaker device 16 toward the position of vocal part 31a of user 31. Audio processing circuit 15 outputs the processed audio signal as a voice from speaker device 16.

When the detection is not made that vocal part 31a is located within a predetermined distance from wearable translation device 1 or the detection is not made that vocal part 31a is located in a specific direction with respect to wearable translation device 1 (for example, above wearable translation device 1), audio processing circuit 15 ends the process and does not output a voice.

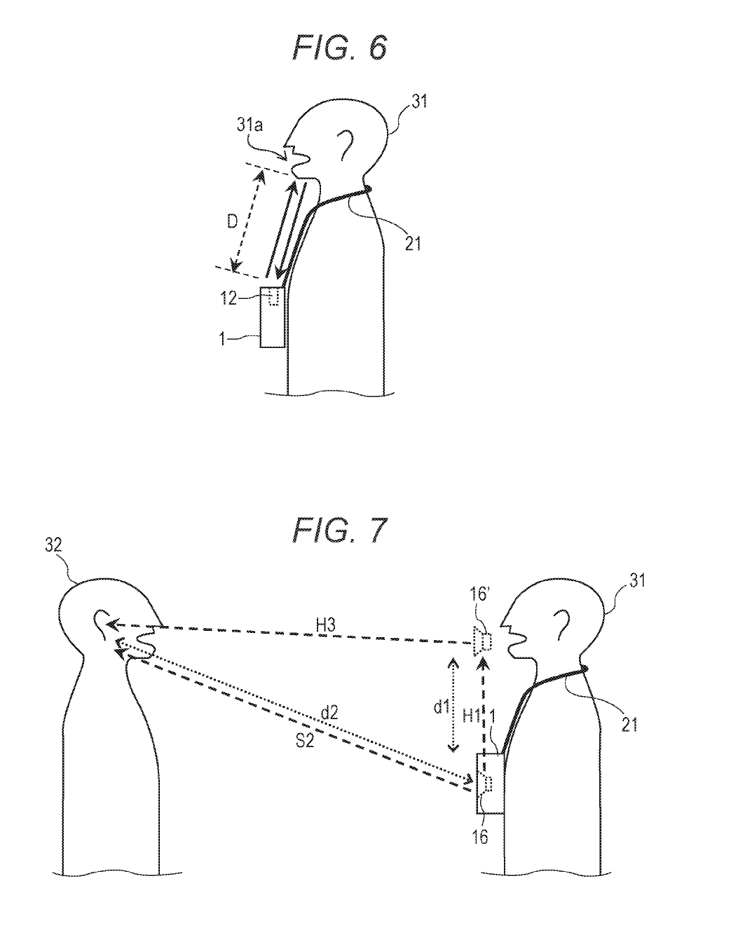

FIG. 6 is a diagram illustrating measurement of a distance between speaker device 16 of wearable translation device 1 of the translation system and vocal part 31a of user 31 according to the first exemplary embodiment.

Distance measuring device 12 is disposed so as to be positioned at an upper surface of wearable translation device 1 when user 31 wears wearable translation device 1 as shown in FIG. 6, for example. Distance measuring device 12 has a speaker and a microphone. Distance measuring device 12 radiates an impulse signal toward vocal part 31a of user 31 using the speaker of distance measuring device 12, and the microphone of distance measuring device 12 receives the impulse signal reflected from a lower jaw of user 31. As a result, distance measuring device 12 measures distance D between distance measuring device 12 and the lower jaw of user 31. The distance between distance measuring device 12 and speaker device 16 is determined. Since variations in a distance between the lower jaw and the mouth of individual users 31 do not make much difference, the measurement of distance D enables the distance between speaker device 16 and vocal part 31a of user 31 to be obtained.

In one example where the detection is made that vocal part 31a of user 31 is located above speaker device 16, the distance between speaker device 16 and vocal part 31a of user 31 is measured, but another detecting method may be used. The wearable translation device 1 may use any detecting method in which a distance and a direction between wearable translation device 1 and vocal part 31a are detected so that the sound image of speaker device 16 can be moved toward vocal part 31a of user 31.

Further, when user 31 wears wearable translation device 1 as shown in FIG. 3 or FIG. 4, distance measuring device 12 may measure a relative position of vocal part 31a of user 31 with respect to speaker device 16 instead of the distance between speaker device 16 and vocal part 31a of user 31. Distance measuring device 12 may measure the relative position of vocal part 31a of user 31 with respect to speaker device 16 using the technique in PTL 2, for example.

Information about the obtained distance between speaker device 16 and vocal part 31a of user 31 is transmitted to control circuit 11C. Control circuit 11C detects that vocal part 31a of user 31 is located above speaker device 16.

FIG. 7 is a diagram illustrating a rise of a sound image when wearable translation device 1 of the translation system according to the first exemplary embodiment is used. User 31 is a speaker of the first language, and user 31 comes face-to-face with listener 32 who speaks the second language. Under the normal condition where user 31 and listener 32 have a conversation, user 31 faces listener 32 with a distance of 1 m to 3 m between them while they are in a standing or seated posture. When user 31 wears wearable translation device 1 as shown in FIG. 2, for example, wearable translation device 1 is located below vocal part 31a of user 31 and is within a range between a portion right below a neck and a waist of user 31. Further, auditory parts (ears) of listener 32 is in a horizontal plane which is parallel to the ground. In this case, the sound image can be raised through adjustment of a specific frequency component of a voice. When the detection is made that vocal part 31a of user 31 is located above speaker device 16, audio processing circuit 15 adjusts (enhances) the specific frequency component of an audio signal of the second language according to the detection so that the sound image of speaker device 16 is moved from the position of speaker device 16 toward the position of vocal part 31a of user 31.

For example, when the technique in PTL 3 is applied, audio processing circuit 15 operates as follows. Audio processing circuit 15 forms frequency characteristics so that sound pressure frequency characteristics of the voice to be output from speaker device 16 to listener 32 have a first peak and a second peak. A center frequency of the first peak is set within a range of 6 kHz±15%. A center frequency of the second peak is set within a range of 13 kHz±20%. A level of the first peak may be set within a range between 3 dB and 12 dB (inclusive), and a level of the second peak may be set within a range between 3 dB and 25 dB (inclusive). The first peak or the second peak may be set based on the sound pressure frequency characteristics of speaker device 16. The sound pressure frequency characteristics of the voice to be output from speaker device 16 may have a characteristic curve in which a dip is formed somewhere in a range of 8 kHz±10%. The dip may be set based on the sound pressure frequency characteristics of speaker device 16. The level or a Q value of the first peak or the second peak may be adjustable. Audio processing circuit 15 may be configured so that a high-band level in the sound pressure frequency characteristics of the voice to be output from speaker device 16 to listener 32 is boosted by a predetermined level.

Even when speaker device 16 is distant from vocal part 31a of user 31, audio processing circuit 15 raises the sound image of speaker device 16 from the position of speaker device 16 toward vocal part 31a of user 31 by forming the audio signal so as to have the predetermined frequency characteristics. As a result, a sound image can be formed at a position of virtual speaker device 16′ as shown in FIG. 7.

The specific frequency component of the audio signal of the second language is expressed by f, the distance between speaker device 16 and virtual speaker device 16′ is expressed by d1, the distance between speaker device 16 and ears of listener 32 is expressed by d2, an audio signal to be output from speaker device 16 is expressed by S2(f) (f expresses a frequency), the transfer function from speaker device 16 to virtual speaker device 16′ is expressed by H1(f, d1), and the transfer function from virtual speaker device 16′ to the ears of listener 32 is expressed by H3(f, d2). At this time, an audio signal to be heard by listener 32 is expressed by formula (1) below.

S2(f)·H1(f, d1)·H3(f, d2) (1)

Audio processing circuit 15 is capable of moving the sound image of speaker device 16 at resolution of the order of, for example, 10 cm.

Wearable translation device 1 may have a gravity sensor that detects whether wearable translation device 1 is practically motionless. When wearable translation device 1 is moving, the accurate distance between speaker device 16 and vocal part 31a of user 31 is incapable of being measured. In this case, the measurement of the distance between speaker device 16 and vocal part 31a of user 31 may be suspended. Alternatively, when wearable translation device 1 is moving, the distance between speaker device 16 and vocal part 31a of user 31 is roughly measured. Audio processing circuit 15 may then move the sound image of speaker device 16 from the position of speaker device 16 toward the position of vocal part 31a of user 31 based on the roughly measured distance.

First, when user 31 wears wearable translation device 1, for example, distance measuring device 12 roughly measures the distance between speaker device 16 and vocal part 31a of user 31. Audio processing circuit 15 may move the sound image of speaker device 16 from the position of speaker device 16 toward the position of vocal part 31a of user 31 based on the roughly measured distance. Then, distance measuring device 12 measures the distance between speaker device 16 and vocal part 31a of user 31 more accurately. Audio processing circuit 15 may then move the sound image of speaker device 16 from the position of speaker device 16 toward the position of vocal part 31a of user 31 based on the measured accurate distance between speaker device 16 and vocal part 31a of user 31.

### 1-3. Effects

Wearable translation device 1 of translation system 100 according to the first exemplary embodiment can be attached to a body of user 31. Wearable translation device 1 includes microphone device 13 that obtains a voice of a first language from user 31 and generates an audio signal of the first language, and control circuit 11 that obtains an audio signal of a second language converted from the audio signal of the first language. Wearable translation device 1 further includes audio processing circuit 15 that executes a predetermined process on the audio signal of the second language, and speaker device 16 that outputs the processed audio signal of the second language as a voice. Further, when detection is made that vocal part 31a of user 31 is located above speaker device 16, audio processing circuit 15 moves the sound image of speaker device 16 from the position of speaker device 16 to the position of vocal part 31a of user 31 according to the detection.

Above-described wearable translation device 1 is capable of keeping natural conversations between speakers of different languages even when wearable translation device 1 translates the conversations. As a result, the translation can be carried out giving users such feelings as “simpleness” and “lightness”, which are characteristics of a wearable translation device.

Further, since audio processing circuit 15 moves the synthesized sound image of the voice toward the position of vocal part 31a of user 31, user 31 can feel as if user 31 is speaking a foreign language during the translation.

Further, wearable translation device 1 of translation system 100 according to the first exemplary embodiment may be attached to a thoracic region or an abdominal region of user 31. As a result, the translation can be carried out giving users such feelings as “simpleness” and “lightness”, which are characteristics of a wearable translation device.

Further, in wearable translation device 1 of translation system 100 according to the first exemplary embodiment, audio processing circuit 15 may adjust a specific frequency component of the audio signal of the second language. Audio processing circuit 15 can raise the sound image by adjusting the specific frequency component of a voice.

Further, in wearable translation device 1 of translation system 100 according to the first exemplary embodiment, microphone device 13 may have a beam in a direction from microphone device 13 toward vocal part 31a of user 31. As a result, wearable translation device 1 is less susceptible to noises other than a voice of user 31 (for example, a voice of listener 32 in FIG. 7).

Further, wearable translation device 1 of translation system 100 according to the first exemplary embodiment may further include distance measuring device 12 that measures the distance between speaker device 16 and vocal part 31a of user 31. As a result, the sound image of speaker device 16 can be suitably moved from the position of speaker device 16 toward the position of vocal part 31a of user 31 based on the actual distance between speaker device 16 and vocal part 31a of user 31.

Further, translation system 100 according to the first exemplary embodiment includes wearable translation device 1, speech recognition server device 3, machine translation server device 4, and voice synthesis server device 5. Speech recognition server device 3, machine translation server device 4, and voice synthesis server device 5 are provided outside wearable translation device 1. Further, speech recognition server device 3 converts an audio signal of a first language into a text of the first language. Further, machine translation server device 4 converts the text of the first language into a text of a second language. Further, voice synthesis server device 5 converts the text of the second language into an audio signal of the second language. Further, control circuit 11 obtains the audio signal of the second language from voice synthesis server device 5 via wireless communication circuit 14. As a result, the configuration of wearable translation device 1 can be simplified. For example, speech recognition server device 3, machine translation server device 4, and voice synthesis server device 5 may be provided by a third party (cloud service) different from a manufacturer or a seller of wearable translation device 1. Use of the cloud service can provide, for example, multi-lingual wearable translation device at low cost.

### Second Exemplary Embodiment

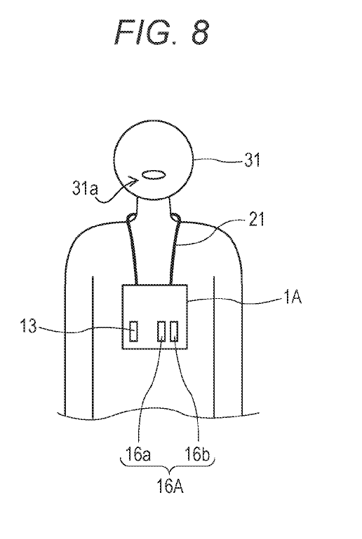

A wearable translation device of a translation system according to the second exemplary embodiment is described below with reference to FIG. 8.

Configurations that are similar to the configurations of translation system 100 and wearable translation device 1 in the first exemplary embodiment are denoted by the same symbols and description thereof is occasionally omitted.

### 2-1. Configuration

FIG. 8 is a diagram illustrating an example of a state in which user 31 wears wearable translation device 1A of the translation system according to the second exemplary embodiment. Wearable translation device 1A is provided with speaker device 16A including a plurality of speakers 16a, 16b instead of speaker device 16 of FIG. 1. In the other points, wearable translation device 1A of FIG. 8 is configured similarly to wearable translation device 1 in FIG. 1.

### 2-2. Operation

Two speakers 16a, 16b of speaker device 16A are disposed so as to be close to each other, and perform stereo dipole reproduction. Audio processing circuit 15 filters the audio signal of the second language based on a distance between speaker device 16A and vocal part 31a of user 31 and a head-related transfer function of a virtual person or listener who is face-to-face with user 31 so that an sound image of speaker device 16A is moved from a position of speaker device 16A toward a position of vocal part 31a of user 31. The head-related transfer function is calculated assuming that the listener faces user 31 with a distance of 1 m to 3 between them. As a result, similarly to the first exemplary embodiment (FIG. 7), even when speaker device 16A is distant from vocal part 31a of user 31, the sound image of speaker device 16A can be raised from the position of speaker device 16A to the position of vocal part 31a of user 31.

Alternatively, when wearable translation device 1A is attached as shown in FIG. 3 or FIG. 4, audio processing circuit 15 may distribute the audio signal of the second language and may adjust a phase of each of distributed audio signals so that a voice to be output from speaker device 16A has a beam in a specific direction. As a result, the direction of the beam of the voice to be output from speaker device 16A can be changed.

For example, the technique in PTL 4 may be applied for changing the direction of the beam of the voice to be output from speaker device 16A.

### 2-3. Effect

In wearable translation device 1A according to the second exemplary embodiment, speaker device 16A includes two speakers 16a, 16b disposed to be close to each other, and may perform the stereo dipole reproduction. Audio processing circuit 15 may filter the audio signal of the second language based on the distance between speaker device 16A and vocal part 31a of user 31 and the head-related transfer function of a virtual person who is face-to-face with user 31. As a result, the sound image of speaker device 16A can be moved from the position of speaker device 16A toward the position of vocal part 31a of user 31 by using the technique of the stereo dipole reproduction.

In wearable translation device 1A according to the second exemplary embodiment, speaker device 16A may include a plurality of the speakers 16a, 16b. Audio processing circuit 15 may distribute the audio signal of the second language and may adjust a phase of each of the distributed audio signals so that the voice to be output from speaker device 16A has a beam in a specific direction. As a result, even when wearable translation device 1A is not located below vocal part 31a of user 31, the sound image of speaker device 16A can be moved from the position of speaker device 16A to the position of vocal part 31a of user 31.

### Third Exemplary Embodiment

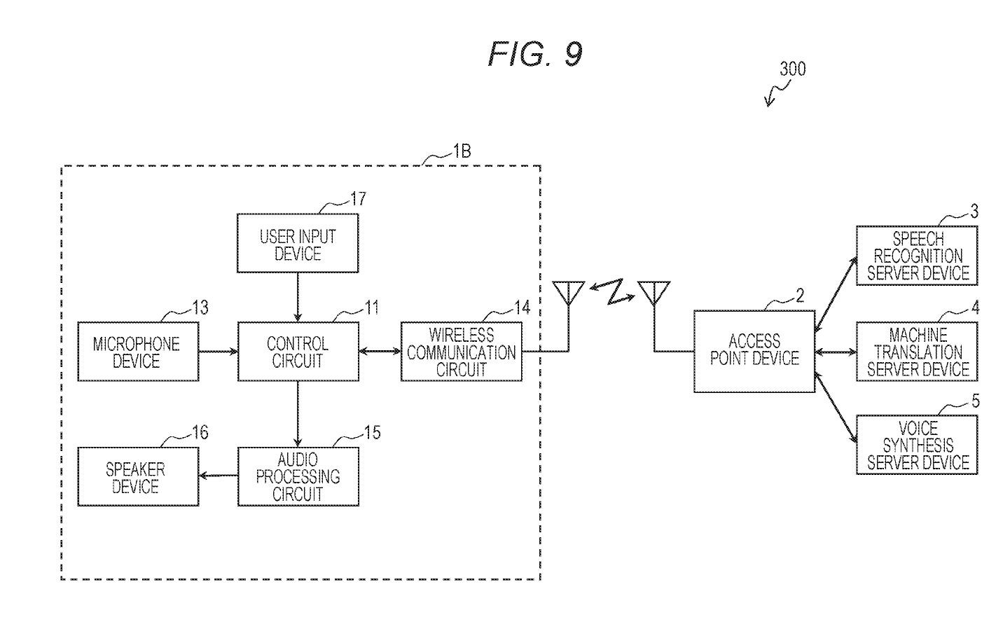

The translation system according to the third exemplary embodiment is described below with reference to FIG. 9.

Configurations that are similar to the configurations of translation system 100 and wearable translation device 1 in the first exemplary embodiment are denoted by the same symbols and description thereof is occasionally omitted.

### 3-1. Configuration

FIG. 9 is a block diagram illustrating a configuration of translation system 300 according to the third exemplary embodiment. Wearable translation device 1B of translation system 300 in FIG. 9 includes user input device 17 instead of distance measuring device 12 in FIG. 1. In the other points, wearable translation device 1B in FIG. 9 is configured similarly to wearable translation device 1 in FIG. 1.

### 3-2. Operation

User input device 17 obtains a user input that specifies a distance between speaker device 16 and vocal part 31a of a user. User input device 17 is formed by a touch panel, buttons, or such other device.

A plurality of predetermined distances (for example, far (60 cm), middle (40 cm), and close (20 cm)) is selectively set in wearable translation device 1B.

The user can select any one of these distances using user input device 17. Control circuit 11C determines a distance between speaker device 16 and vocal part 31a of the user (dl in FIG. 7) according to an input signal (selection of the distance) from user input device 17. As a result, control circuit 11C detects that vocal part 31a of user 31 is located above speaker device 16.

### 3-3. Effect

In translation system 300 according to the third exemplary embodiment, wearable translation device 1B includes user input device 17 that obtains a user input that specifies the distance between speaker device 16 and vocal part 31a of the user. Since distance measuring device 12 in FIG. 1 is removed, the configuration of wearable translation device 1B in FIG. 9 is simpler than the configuration of wearable translation device 1 in FIG. 1.

### Fourth Exemplary Embodiment

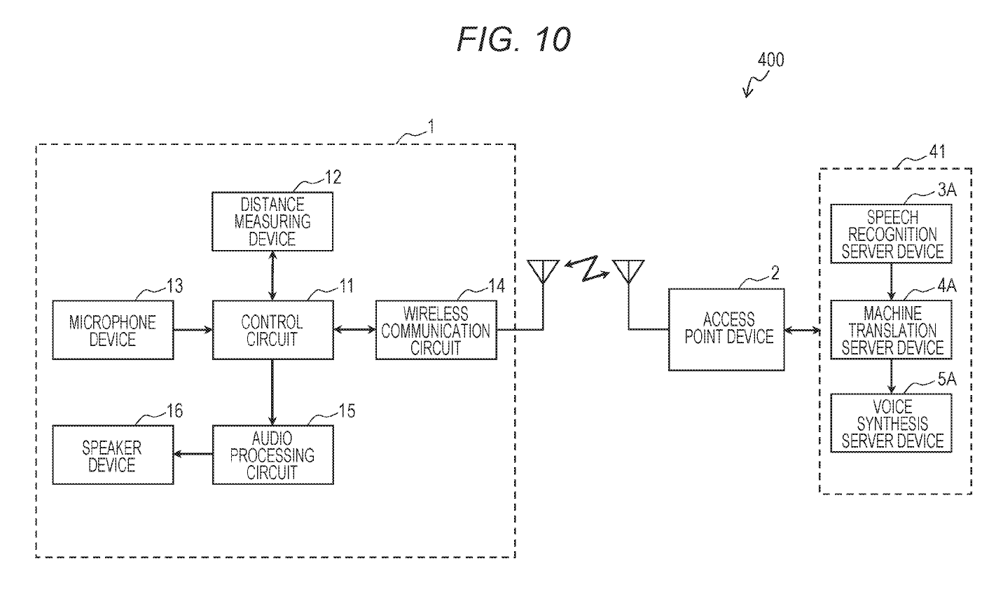

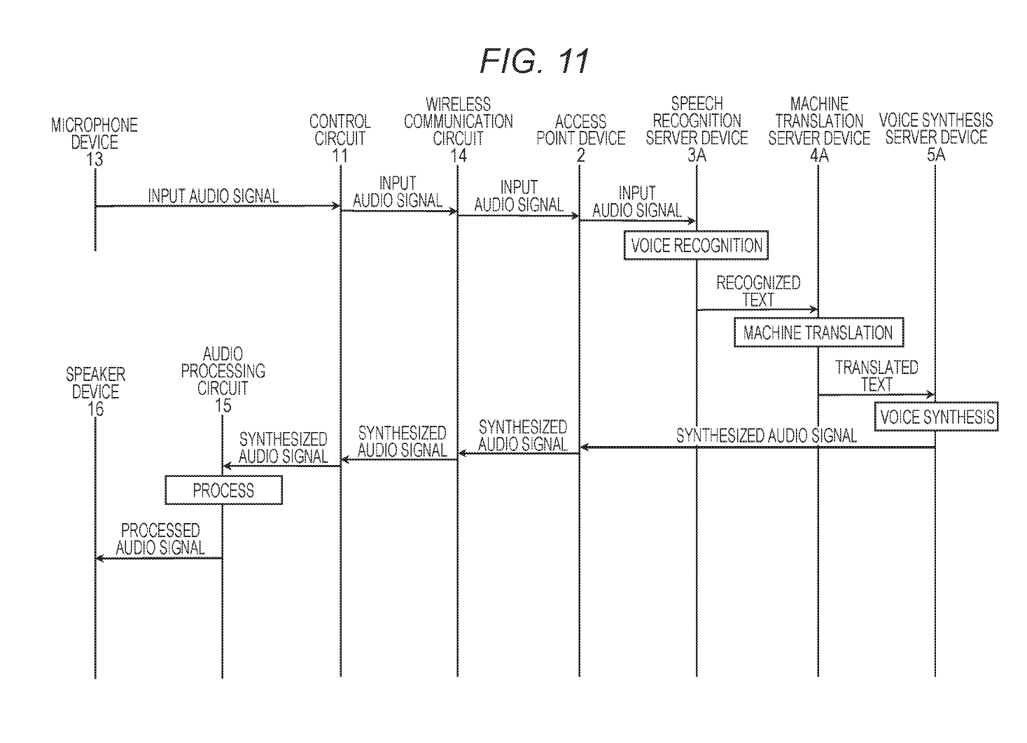

The translation system according to the fourth exemplary embodiment is described below with reference to FIG. 10 and FIG. 11.

Configurations that are similar to the configurations of translation system 100 and wearable translation device 1 in the first exemplary embodiment are denoted by the same symbols and description thereof is occasionally omitted.

### 4-1. Configuration

FIG. 10 is a block diagram illustrating a configuration of translation system 400 according to the fourth exemplary embodiment. Translation system 400 includes wearable translation device 1, access point device 2, and translation server device 41. Translation server device 41 includes speech recognition server device 3A, machine translation server device 4A, and voice synthesis server device 5A. Wearable translation device 1 and access point device 2 in FIG. 10 are configured similarly to wearable translation device 1 and access point device 2 in FIG. 1. Speech recognition server device 3A, machine translation server device 4A, and voice synthesis server device 5A in FIG. 10 have functions that are similar to the functions of speech recognition server device 3, machine translation server device 4, and voice synthesis server device 5 in FIG. 1, respectively. Access point device 2 communicates with translation server device 41 via, for example, the Internet. Therefore, wearable translation device 1 communicates with translation server device 41 via access point device 2.

### 4-2. Operation

FIG. 11 is a sequence diagram illustrating an operation of translation system 400 according to the fourth exemplary embodiment. When an audio signal of a first language is input from user 31 via microphone device 13, control circuit 11 transmits the input audio signal to translation server device 41. Speech recognition server device 3A of translation server device 41 performs speech recognition on the input audio signal, and generates a text of the recognized first language so as to transmit the text to machine translation server device 4A. Machine translation server device 4A performs machine translation on the text of the first language and generates a translated text of the second language so as to transmit the text to voice synthesis server device 5A. Voice synthesis server device 5A performs voice synthesis on the text of the second language and generates an audio signal of the synthesized second language so as to transmit the audio signal to control circuit 11. When control circuit 11 receives the audio signal of the second language from translation server device 41, control circuit 11 transmits the audio signal of the second language to audio processing circuit 15. When detection is made that vocal part 31a of user 31 is located above speaker device 16, audio processing circuit 15 processes the audio signal of the second language according to the detection, so that a sound image of speaker device 16 is moved from a position of speaker device 16 toward a position of vocal part 31a of user 31. Audio processing circuit 15 then outputs the processed audio signal as a voice from speaker device 16.

### 4-3. Effect

Translation system 400 according to the fourth exemplary embodiment may include speech recognition server device 3A, machine translation server device 4A, and voice synthesis server device 5A as integrated translation server device 41. As a result, the number of communications by translation system 400 can be made to be smaller than the number of communications by the translation system according to the first exemplary embodiment, so that a time and power consumption necessary for the communications can be reduced.

### Fifth Exemplary Embodiment

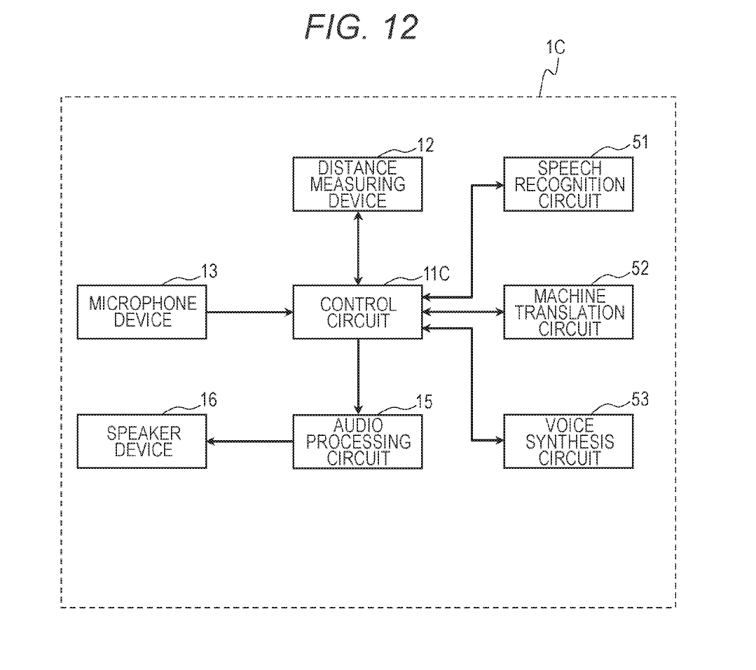

A wearable translation device according to the fifth exemplary embodiment is described below with reference to FIG. 12.

Configurations that are similar to the configurations of translation system 100 and wearable translation device 1 in the first exemplary embodiment are denoted by the same symbols and description thereof is occasionally omitted.

### 5-1. Configuration

FIG. 12 is a block diagram illustrating a configuration of wearable translation device 1C according to the fifth exemplary embodiment. Wearable translation device 1C in FIG. 12 has functions of speech recognition server device 3, machine translation server device 4, and voice synthesis server device 5 in FIG. 1. Wearable translation device 1C includes control circuit 11C, distance measuring device 12, microphone device 13, audio processing circuit 15, speaker device 16, speech recognition circuit 51, machine translation circuit 52, and voice synthesis circuit 53. Distance measuring device 12, microphone device 13, audio processing circuit 15, and speaker device 16 in FIG. 12 are configured similarly to corresponding components in FIG. 1. Speech recognition circuit 51, machine translation circuit 52, and voice synthesis circuit 53 have functions that are similar to the functions of speech recognition server device 3, machine translation server device 4, and voice synthesis server device 5 in FIG. 1. Control circuit 11C obtains an audio signal of a second language from speech recognition circuit 51, machine translation circuit 52, and voice synthesis circuit 53. The audio signal of the second language is translated from an audio signal of a first language.

### 5-2. Operation

When the audio signal of the first language is input from a user via microphone device 13, control circuit 11C transmits the input audio signal to speech recognition circuit 51. Speech recognition circuit 51 executes speech recognition on the input audio signal, generates a text of the recognized first language, and transmits the text to control circuit 11C. When control circuit 11C receives the text of the first language from speech recognition circuit 51, control circuit 11C transmits the text of the first language as well as a control signal to machine translation circuit 52. The control signal includes an instruction to translate the text from the first language to the second language. Machine translation circuit 52 performs machine translation on the text of the first language, generates a translated text of the second language, and transmits the text to control circuit 11C. When control circuit 11C receives the text of the second language from machine translation circuit 52, control circuit 11C transmits the text of the second language to voice synthesis circuit 53. Voice synthesis circuit 53 performs voice synthesis on the text of the second language, generates an audio signal of the synthesized second language, and transmits the audio signal to control circuit 11C. When control circuit 11C receives the audio signal of the second language from voice synthesis circuit 53, control circuit 11C transmits the audio signal of the second language to audio processing circuit 15. When detection is made that vocal part 31a of the user is located above speaker device 16, audio processing circuit 15 processes the audio signal of the second language according to the detection so that a sound image of speaker device 16 is moved from a position of speaker device 16 toward a position of vocal part 31a of the user. Audio processing circuit 15 then outputs the processed audio signal as a voice from speaker device 16.

Speech recognition circuit 51 performs speech recognition on the input audio signal, and generates a text of the recognized first language. Speech recognition circuit 51 may, then, transmit the text not to control circuit 11C but to machine translation circuit 52. Similarly, machine translation circuit 52 performs machine translation on the text of the first language, and generates a translated text of the second language. Machine translation circuit 52 may then transmit the text not to control circuit 11C but to voice synthesis circuit 53.

### 5-3. Effect

Wearable translation device 1C according to the fifth exemplary embodiment may further include speech recognition circuit 51 that converts an audio signal of a first language into a text of the first language, machine translation circuit 52 that converts the text of the first language into a text of a second language, and voice synthesis circuit 53 that converts the text of the second language into an audio signal of the second language. Control circuit 11C may obtain the audio signal of the second language from voice synthesis circuit 53. As a result, wearable translation device 1C can translate conversations between speakers of different languages without communicating with an external server device.

### Other Exemplary Embodiments

The first to fifth exemplary embodiments are described above as examples of the technique disclosed in the present application. However, the technique in the present disclosure is not limited to the first to the fifth exemplary embodiments and can be applied also to exemplary embodiments where modifications, substitutions, additions and omissions are suitably performed. Further, the various components described in the first to fifth exemplary embodiments are combined so that a new exemplary embodiment can be constructed.

Other exemplary embodiments are illustrated below.

The first to fourth exemplary embodiments describe wireless communication circuit 14 as one example of the communication circuit of the wearable translation device. However, any communication circuit may be used as long as it can communicate with a speech recognition server device, a machine translation server device, and a voice synthesis server device, which are provided on the outside of the circuit. Therefore, the wearable translation device may be connected with the speech recognition server device, the machine translation server device, and the voice synthesis server device on the outside of the wearable translation device via a wire.

The first to fifth exemplary embodiments illustrate the control circuit, the communication circuit, and the audio processing circuit of the wearable translation device as individual blocks, but these circuits may be configured as a single integrated circuit chip. Further, the functions of the control circuit, the communication circuit, and the audio processing circuit of the wearable translation device may be constructed by a general-purpose processor that executes programs.

The first to fifth exemplary embodiments describe the case where only one user (speaker) uses the wearable translation device, but the wearable translation device may be used by a plurality of speakers who tries to have conversations with each other.

According to the first to fifth exemplary embodiments, a sound image of the speaker device is moved from a position of the speaker device toward a position of vocal part 31a of a user. However, the sound image of the speaker device may be moved from the position of the speaker device toward a position other than the position of vocal part 31a of the user.

The exemplary embodiments are described above as the examples of the technique in the present disclosure. For this purpose, the accompanying drawings and the detailed description are provided.

Therefore, the components described in the accompanying drawings and the detailed description may include not only components essential for solving the problem but also components that are not essential for solving the problem in order to illustrate the technique. Therefore, even when the unessential components are described in the accompanying drawings and the detailed description, they do not have to be recognized as being essential.

Further, since the above exemplary embodiments illustrate the technique in the present disclosure, various modifications, substitutions, additions and omission can be performed within the scope of claims and equivalent scope of claims.

The present disclosure can provide a wearable device that is capable of keeping natural conversations between speakers of different languages during translation.

What is claimed is:

1. A wearable device comprising:
a microphone device that obtains a voice of a first language from the user and generates an audio signal of the first language;
a control circuit that obtains an audio signal of a second language converted from the audio signal of the first language;
an audio processing circuit that executes a predetermined process on the audio signal of the second language; and
a speaker device that outputs the processed audio signal of the second language as a voice,
wherein when detection is made that a vocal part of the user is located above the speaker device, the audio processing circuit moves a sound image of the speaker device from a position of the speaker device toward a position of the vocal part of the user according to the detection.

2. The wearable device according to claim 1, wherein when the vocal part of the user is not detected, the audio processing circuit does not move the sound image of the speaker device.

3. The wearable device according to claim 1, wherein the audio processing circuit adjusts a specific frequency component of the audio signal of the second language.

4. The wearable device according to claim 1, wherein
the speaker device includes two speakers that are disposed to be close to each other and executes stereo dipole reproduction, and
the audio processing circuit filters the audio signal of the second language based on a distance between the speaker device and the vocal part of the user and a head-related transfer function of a virtual person who is face-to-face with the user.

5. The wearable device according to claim 1, wherein
the speaker device includes a plurality of speakers, and
the audio processing circuit distributes the audio signal of the second language so that a voice to be output from the speaker device has a beam in a specific direction, and adjusts a phase of each of the distributed audio signals.

6. The wearable device according to claim 1, wherein the microphone device has a beam in a direction from the microphone device toward the vocal part of the user.

7. The wearable device according to claim 1, further comprising a distance measuring device that measures a distance between the speaker device and the vocal part of the user.

8. The wearable device according to claim 1, further comprising a user input device that obtains a user input for specifying a distance between the speaker device and the vocal part of the user.

9. The wearable device according to claim 1, further comprising:
a speech recognition circuit that converts the audio signal of the first language into a text of the first language;
a machine translation circuit that converts the text of the first language into a text of the second language; and
a voice synthesis circuit that converts the text of the second language into the audio signal of the second language,
wherein the control circuit obtains the audio signal of the second language from the voice synthesis circuit.

10. A translation system comprising:
the wearable device of claim 1 further including a communication circuit;
a speech recognition server device connectable with the wearable device;
a machine translation server device connectable with the wearable device; and
a voice synthesis server device connectable with the wearable device,
wherein the speech recognition server device converts the audio signal of the first language into a text of the first language,
the machine translation server device converts the text of the first language into a text of the second language,
the voice synthesis server device converts the text of the second language into the audio signal of the second language, and
the control circuit obtains the audio signal of the second language from the voice synthesis server device via the communication circuit.

11. The translation system according to claim 10, wherein the speech recognition server device, the machine translation server device, and the voice synthesis server device are formed by an integrated translation server device.
